(19) United States
(12) Patent Application Publication
(10) Pub. No.: US 2005/0006113 A1
(43) Pub. Date: Jan. 13, 2005

(54) Method for controlling the operation time of an electric nailer

(76) Inventor: Dandy Tsai, Taichung (TW)

Correspondence Address: CHARLES E. BAXLEY, ESQ., 90 JOHN STREET, THIRD FLOOR, NEW YORK, NY, 10038, US

(21) Appl. No.: 10/616,741

(22) Filed: Jul. 9, 2003

(51) Int. Cl. B27F 7/00

(52) U.S. Cl. 173/1; 227/131

(57) ABSTRACT

A method for controlling operation time of an electric nailer, which comprises a power source, an electromagnetic coils, a control unit and moving member, all of which are disposed in a housing of an electric tool. Wherein the power source generates DC power for a predetermined voltage value that provides the power for the electromagnetic coils and the control unit for enabling them to generate electromagnetic forces and actuate respectively. The control unit serves to control the output of the DC power source at a standard reference potential or predetermined potential, by such arrangements, the control unit is capable of actuating the electromagnetic coils at any period of time.

### BACKGROUND OF THE INVENTION

1. Field of the Invention

The present invention relates to a method for controlling the operation time of an electric nailer, and more particular to a method for enabling the electric nailer to work at any period of time.

2. Description of the Prior Arts

Electric nailer has been commonly used and the technology of nailer and electricity are getting more and more ripe, the power source can be obtained without difficulty, so, nowadays the electric nailer has become the users' first preference.

A conventional electromagnetic nailer of the electric nailer generally includes a control switch (such as SCR), an electromagnetic coils, a driver and an elastic member. When the electromagnetic coils is energized which effects a stroke of the driver, then, after the stroke, the driver will be forced back to its original non-operative position by the elastic member, that's an operation cycle and to be cycled repeatedly. However, still there are some disadvantages will be caused in real operation as illustrated below:

First, referring to FIG. 1, a conventional electromagnetic nailer is normally alternating current (AC) energized. Due to AC power periodically reverses the current or voltage (sine wave normally), the electrification of the control switch will accordingly start from the first point 111 of the positive cycle 11, the electromagnetic coils begin to generate magnetic force simultaneously. The electrification of the control switch will not be stopped until the second point 112 of the positive cycle 11, right begin from this point 112, the electromagnetic coils stopped effecting magnetic force and effect a stroke of the driver. While during the negative cycle 12, the electromagnetic coils can't generate magnetic force cause it is not electrified, which results in a failure of stroke. Thereby the conventional electric tool can only work at some specific points of time.

The present invention has arisen to mitigate and/or obviate the afore-described disadvantages of the conventional electric tool.

### SUMMARY OF THE INVENTION

In accordance with one aspect of the present invention, there is provided a method for controlling operation time of an electric nailer, which comprises a power source, an electromagnetic coils, a control unit and moving member, all of which are disposed in a housing of an electric tool. Wherein the power source generates direct current (DC) power for a predetermined voltage value that provides the power for the electromagnetic coils and the control unit for enabling them to generate electromagnetic forces and actuate respectively. The control unit serves to control the output of the DC power source at a standard reference potential or predetermined potential, by such arrangements, the control unit is capable of actuating the electromagnetic coils at any period of time.

The primary object of the present invention is to provide a method for controlling operation time of an electric nailer, by virtue of a DC power source together with a control unit, the electric nailer is workable at any period of time whereby to increase the working efficiency.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is a schematic diagram of illustrating an electric wave form of an AC for a conventional electric nailer;

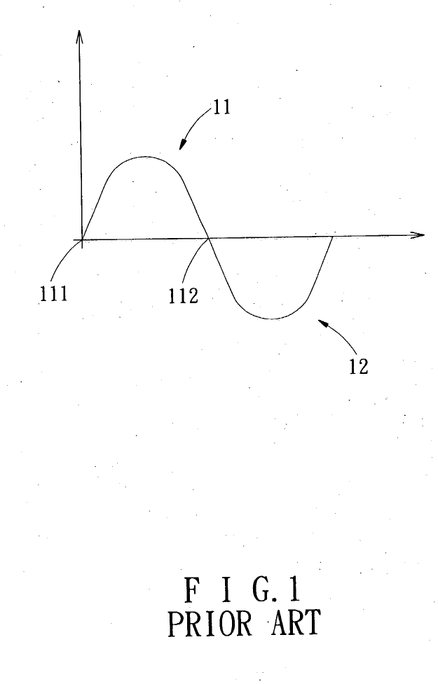

FIG. 2 is a schematic block diagram in accordance with the present invention of illustrating the method for controlling operation time of an electric nailer;

FIG. 3 is a cross-sectional view of an electric nailer equipped with control unit in accordance with the present invention;

FIG. 4 is a circuit diagram of the present invention;

FIG. 5 is a schematic diagram of illustrating an electric wave form of a DC for the electric nailer of the present invention.

### DETAILED DESCRIPTION OF THE PREFERRED EMBODIMENT

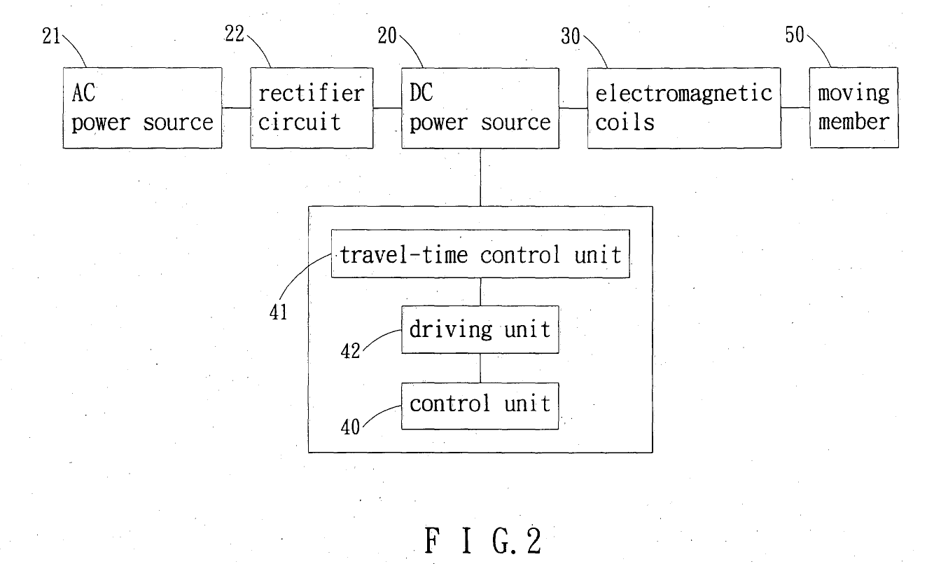

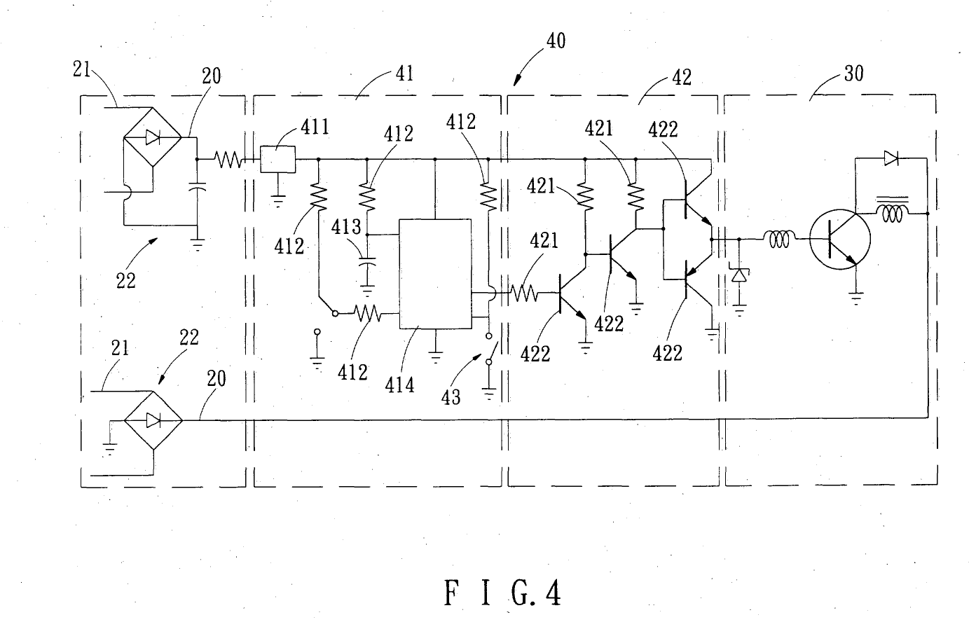

Referring to FIGS. 2-4, wherein a method for controlling operation time of an electric nailer is illustrated and the electric nailer generally includes a power source 20, electromagnetic coils 30, a control unit 40 and a moving member 50.

The power source 20 is a DC with a predetermined voltage, which can be obtained by direct connecting to AC power source 21 and then turning the AC into DC through a rectifier circuit 22. Due to it is conventional rectifying method and has been known very well further remarks on this matter will seem superfluous. It will be noted that the power source 20 also can be generated from a dry DC battery.

The electromagnetic coils 30 consist of a plurality of windings 31 and interiorly define a passage 32, the electromagnetic coils 30 is energized by connecting to the power source 20 and actuated to generate and/or stop a magnetic force.

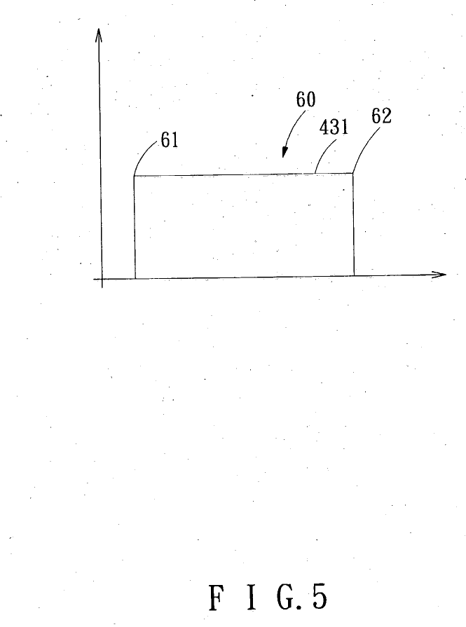

The control unit 40 includes a travel-time control unit 41 connecting with a driving unit 42. Wherein the travel-time control unit 41 is connected to the power source 20, while the driving unit 40 links to the electromagnetic coils 30. The travel-time control unit 41 is comprised of a voltage regulation element 411, four current limit resistances 412, a time-control capacitor 413 and a time-control integrated circuit 414 and under control of a push button switch 43. Such that the push button switch 43 is able to control the output of the DC power source at a standard reference potential 431 or a predetermined potential 432 (see FIG. 5). The driving unit 42 includes three voltage-divider resistances 421 and four driving transistors 422, which serves to actuate the electromagnetic coils 30.

The moving member 50 is a driver, which has an extended striking pin element 51 fixed at the front end and an elastic member 52 mounted at the rear end. Then the moving member 50 is movably received in the passage 32 of the electromagnetic coils 30 and relatively moves therein driven by the magnetic forces effected or stopped by the electromagnetic coils 4.

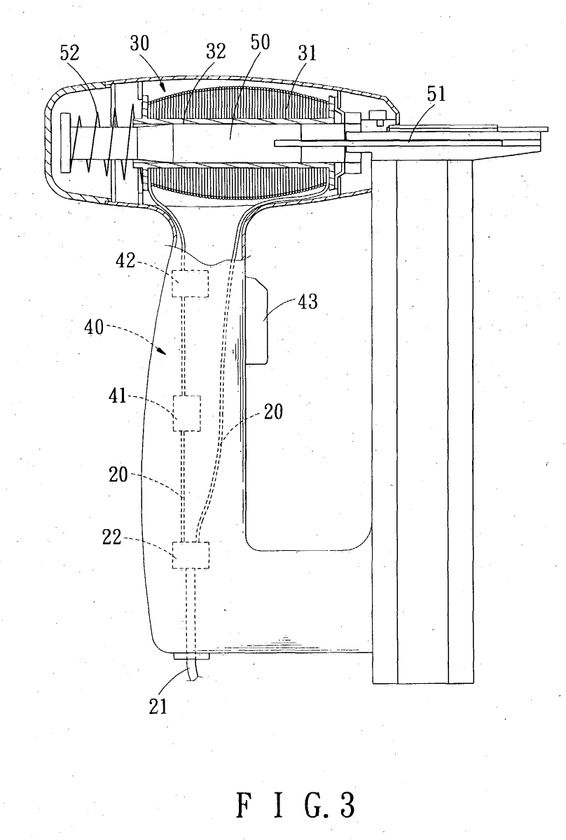

Referring to FIGS. 3 and 5, due to the output of the power source 20 is DC power, the magnitude of the output voltage/current and polarity of the DC power source won't be changed with the change of time. Thereby, the travel-time control unit 41 of the control unit 40 can be electrified by pushing the push switch 43 during the period of time from the first time point 61 to the second time point 62 of the DC wave form 60 (predetermined potential 432) so as to enable the driving unit 42 to actuate and energize the electromagnetic coils 30, finally give rise to strokes of the moving member 50. Thereby the electric nailer in accordance with the present invention is workable at any period of time.

While we have shown and described various embodiments in accordance with the present invention, it should be clear to those skilled in the art that further embodiment may be made without departing from the scope of the present invention.

1. A method for controlling operation time of an electric nailer comprising:
a power source providing power at a predetermined voltage;
a set of electromagnetic coils connected to the power source and actuated to effect and to stop magnetic forces;
a control unit connected to the power source and employed to actuate the electromagnetic coils;
a moving member moved by the magnetic forces generated by the electromagnetic coils;
wherein the power source provides DC power for a predetermined voltage, the DC power source provides power for the electromagnetic coils for generating the electromagnetic forces, and supply power to the control unit for actuating the electromagnetic coils, the control unit serves to control the output of the DC power at a standard reference potential and at a predetermined potential, by such arrangements, the control unit having an ability of actuating the electromagnetic coils at any period of time.

2. The method for controlling operation time of an electric nailer as claimed in claim 1, wherein the control unit further comprises a time-control unit connected with a driving unit, the time-control unit is connected to the power source and the driving unit is linked to the electromagnetic coils.

3. The method for controlling operation time of an electric nailer as claimed in claim 2, wherein the time-control unit includes an voltage regulation element, four current limit resistances, a time-control condenser and a integrated circuit (IC).

4. The method for controlling operation time of an electric nailer as claimed in claim 2, wherein the driving unit includes three voltage-divider resistances and four transistors for serving to actuate the electromagnetic coils.

5. The method for controlling operation time of an electric nailer as claimed in claim 1, wherein the moving member is a ram having a striking pin connected at an end.
